(19) United States
(12) Patent Application Publication
(10) Pub. No.: US 2013/0230102 A1
(43) Pub. Date: Sep. 5, 2013

(54) METHODS FOR ENCODING AND DECODING AN IMAGE, AND CORRESPONDING DEVICES

(71) Applicant: CANON KABUSHIKI KAISHA, Tokyo (JP)

(72) Inventors: Sébastien LASSERRE, Rennes (FR); Fabrice LE LEANNEC, Mouaze (FR)

(73) Assignee: CANON KABUSHIKI KAISHA, Tokyo (JP)

(21) Appl. No.: 13/781,266

(22) Filed: Feb. 28, 2013

(30) Foreign Application Priority Data
Mar. 2, 2012 (GB) 1203698.4

(51) Int. Cl. H04N 7/26

(52) U.S. Cl. CPC H04N 19/00763
USPC 375/240.12

(57) ABSTRACT

A method for encoding at least one block of pixels, includes the steps of:
transforming pixel values for said block into a set of coefficients each having a coefficient type;
determining an initial coefficient encoding merit for each coefficient type;
quantizing, into quantized symbols, only coefficients for which the initial coefficient encoding merit is greater than a predetermined block merit; and
encoding the quantized symbols into encoded data.

Corresponding decoding methods, encoding and decoding devices are also proposed.

This application claims priority under 35 USC §119 from United Kingdom Application No. 1203698.4 filed on Mar. 2, 2012, which is incorporated herein by reference.

### FIELD OF THE INVENTION

The present invention concerns methods for encoding and decoding an image comprising blocks of pixels, and an associated encoding device.

The invention is particularly useful for the encoding of digital video sequences made of images or “frames”.

### BACKGROUND OF THE INVENTION

Video compression algorithms, such as those standardized by the standardization organizations ITU, ISO, and SMPTE, exploit the spatial and temporal redundancies of images in order to generate bitstreams of data of smaller size than original video sequences. These powerful video compression tools, known as spatial (or intra) and temporal (or inter) predictions, make the transmission and/or the storage of video sequences more efficient.

Video encoders and/or decoders (codecs) are often embedded in portable devices with limited resources, such as cameras or camcorders. Conventional embedded codecs can process at best high definition (HD) digital videos, i.e 1080×1920 pixel frames.

Real time encoding is however limited by the limited resources of the portable devices, especially regarding slow access to the working memory (e.g. random access memory, or RAM) and regarding the central processing unit (CPU).

This is particularly striking for the encoding of ultra-high definition (UHD) digital videos that are about to be handled by the latest cameras. This is because the amount of pixel data to encode or to consider for spatial or temporal prediction is huge.

UHD is typically four times (4k2k pixels) the definition of an HD video which is the current standard definition video. Furthermore, very ultra high definition, which is sixteen times that definition (i.e. 8k4k pixels), is even being considered in a more long-term future.

### SUMMARY OF THE INVENTION

Faced with these encoding constraints in terms of limited power and memory access bandwidth, the inventors provide a UHD codec with low complexity based on scalable encoding.

Basically, the UHD video is encoded into a base layer and one or more enhancement layers.

The base layer results from the encoding of a reduced version of the UHD images, in particular having a HD resolution, with a standard existing codec (e.g. H.264 or HEVC—High Efficiency Video Coding). As stated above, the compression efficiency of such a codec relies on spatial and temporal predictions.

Further to the encoding of the base layer, an enhancement image is obtained from subtracting an interpolated (or up-scaled) decoded image of the base layer from the corresponding original UHD image. The enhancement images, which are residuals or pixel differences with UHD resolution, are then encoded into an enhancement layer.

FIG. 1 illustrates such approach at the encoder 10.

An input raw video 11, in particular a UHD video, is down-sampled 12 to obtain a so-called base layer, for example with HD resolution, which is encoded by a standard base video coder 13, for instance H.264/AVC or HEVC. This results in a base layer bit stream 14.

To generate the enhancement layer, the encoded base layer is decoded 15 and up-sampled 16 into the initial resolution (UHD in the example) to obtain the up-sampled decoded base layer.

The latter is then subtracted 17, in the pixel domain, from the original raw video to get the residual enhancement layer X.

The information contained in X is the error or pixel difference due to the base layer encoding and the up-sampling. It is also known as a “residual”.

A conventional block division is then applied, for instance a homogenous 8×8 block division (but other divisions with non-constant block size are also possible).

Next, a DCT transform 18 is applied to each block to generate DCT blocks forming the DCT image X_{DCT} having the initial UHD resolution.

This DCT image X_{DCT} is encoded in X_{DCT,Q}^{ENC} by an enhancement video encoding module 19 into an enhancement layer bit stream 20.

The encoded bit-stream EBS resulting from the encoding of the raw video 11 is made of:
the base layer bit-stream 14 produced by the base video encoder 13;
the enhancement layer bit-stream 20 encoded by the enhancement video encoder 19; and
parameters 21 determined and used by the enhancement video encoder.

Examples of those parameters are given here below.

FIG. 2 illustrates the associated processing at the decoder 30 receiving the encoded bit-stream EBS.

Part of the processing consists in decoding the base layer bit-stream 14 by the standard base video decoder 31 to produce a decoded base layer. This decoded base layer is up-sampled 32 into the initial resolution, i.e. UHD resolution.

In another part of the processing, both the enhancement layer bit-stream 20 and the parameters 21 are used by the enhancement video decoding module 33 to generate a dequantized DCT image X̅_{Q}_{^{−1}}^{DEC}. The image X̅_{Q}_{^{−1}}^{DEC} is the result of the quantization and then the inverse quantization on the image X_{DCT}.

An inverse DCT transform 34 is then applied to each block of the image X to obtain the decoded residual X̅_{IDCT,Q}_{^{−1}}^{DEC} (of UHD resolution) in the pixel domain.

This decoded residual X̅_{IDCT,Q}_{^{−1}}^{DEC} is added 35 to the up-sampled decoded base layer to obtain decoded images of the video.

Filter post-processing, for instance with a deblocking filter 36, is finally applied to obtain the decoded video 37 which is output by the decoder 30.

Reducing UHD encoding complexity relies on simplifying the encoding of the enhancement images at the enhancement video encoding module 19 compared to the conventional encoding scheme.

To that end, the inventors dispense with the temporal prediction and possibly the spatial prediction when encoding the UHD enhancement images. This is because the temporal prediction is very expensive in terms of memory bandwidth consumption, since it often requires accessing other enhancement images.

While this simplification reduces by 80% the slow memory random access bandwidth consumption during the encoding process, not using those powerful video compression tools may deteriorate the compression efficiency, compared to the conventional standards.

In this respect, the inventors have developed several additional tools for increasing the efficiency of the encoding of those enhancement images.

FIG. 3 illustrates an embodiment of the enhancement video encoding module 19 (or “enhancement layer encoder”) that is provided by the inventors.

In this embodiment, the enhancement layer encoder models 190 the statistical distribution of the DCT coefficients within the DCT blocks of a current enhancement image by fitting a parametric probabilistic model.

This fitted model becomes the channel model of DCT coefficients and the fitted parameters are output in the parameter bit-stream 21 coded by the enhancement layer encoder. As will become more clearly apparent below, a channel model may be obtained for each DCT coefficient position within a DCT block, i.e. each type of coefficient or each DCT channel, based on fitting the parametric probabilistic model onto the corresponding collocated DCT coefficients throughout all the DCT blocks of the image X_{DCT} or of part of it.

Based on the channel models, quantizers may be chosen 191 from a pool of pre-computed quantizers dedicated to each DCT channel as further explained below.

The chosen quantizers are used to perform the quantization 192 of the DCT image X, to obtain the quantized DCT image X_{DCT,Q}.

Lastly, an entropy encoder 193 is applied to the quantized DCT image X_{DCT,Q} to compress data and generate the encoded DCT image X_{DCT,Q}^{ENC} which constitutes the enhancement layer bit-stream 20.

The associated enhancement video decoder 33 is shown in FIG. 4.

From the received parameters 21, the channel models are reconstructed and quantizers are chosen 330 from the pool of quantizers. As further explained below, quantizers used for dequantization may be selected at the decoder side using a process similar to the selection process used at the encoder side, based on parameters defining the channel models (which parameters are received in the data stream). Alternatively, the parameters transmitted in the data stream could directly identify the quantizers to be used for the various DCT channels.

An entropy decoder 331 is applied to the received enhancement layer bit-stream 20 ( X̅=X_{DCT,Q}^{ENC}) to obtain the quantized DCT image X̅^{DEC}.

A dequantization 332 is then performed by using the chosen quantizers, to obtain a dequantized version of the DCT image X_{Q}_{^{−1}}^{DEC}.

The channel modelling and the selection of quantizers are some of the additional tools as introduced above.

As will become apparent from the explanation below, those additional tools may be used for the encoding of any image, regardless of the enhancement nature of the image, and furthermore regardless of its resolution.

As briefly introduced above, the invention is particularly advantageous when encoding images without prediction.

According to a first aspect, the invention provides a method for encoding at least one block of pixels, comprising the steps of:
transforming pixel values for said block into a set of coefficients each having a coefficient type;
determining an initial coefficient encoding merit for each coefficient type;
quantizing, into quantized symbols, only coefficients for which the initial coefficient encoding merit is greater than a predetermined block merit; and
encoding the quantized symbols into encoded data.

Thus, thanks to the use of the measure provided by the initial coefficient encoding merit, only coefficient types for which encoding is considered as sufficiently efficient will be encoded.

Determining an initial coefficient encoding merit for a given coefficient type includes for instance estimating a ratio between a distortion variation provided by encoding a coefficient having the given type and a rate increase resulting from encoding said coefficient, which is one possible interesting way to measure the encoding merit.

In the practical embodiment described below, the method comprises the following steps:
determining, for each coefficient type, at least one parameter representative of a probabilistic distribution of coefficients having the concerned coefficient type; and
determining the initial coefficient encoding merit for a given coefficient type based on the parameter for the given coefficient type.

This is a particularly convenient way of estimating the initial coefficient encoding merit.

In addition, it may be provided that, for each coefficient for which the initial coefficient encoding merit is greater than the predetermined block merit, a quantizer is selected depending on the parameter for the concerned coefficient type and on the predetermined block merit. The quantizer can thus be selected to best match the situation, in a practical way.

The quantizer is for instance selected such that a merit of encoding the concerned coefficient beyond encoding using said quantizer equals the predetermined block merit. Thus, for the various encoded coefficient over the block, the merit after encoding equals the predetermined block merit, which produces equal merits over encoded coefficients (and lower merits for non-encoded coefficients). This is a particularly efficient yet simple way to distribute encoding over the various blocks.

It may be provided a step of sending encoded data and parameters determined for each coefficient type. Such parameters may then be used at the decoder to determine which coefficient types have been encoded and to select the corresponding quantizers, as further explained below. It may also be provided, for instance as a variation (but also possibly in combination), a step of sending encoded data and flags each associated with a coefficient type and indicative of whether the coefficient having the concerned coefficient type is encoded.

The predetermined block merit may be determined in a prior step based on a predetermined frame merit and on a number of blocks of a block type of the block per area unit. As explained below, this makes it possible to evenly distribute the encoding over the various block types that may be found in a frame.

According to a second aspect, the invention provides a method for decoding data representing at least one block of pixels, the method comprising:
receiving said data and parameters each representative of a probabilistic distribution of a coefficient type;
decoding said data into symbols;
selecting coefficient types for which a coefficient encoding merit prior to encoding, estimated based on the parameter associated with the concerned coefficient type, is greater than a predetermined block merit;
for selected coefficient types, dequantizing symbols into dequantized coefficients having a coefficient type among the selected coefficient types; and
transforming dequantized coefficients into pixel values in the spatial domain for said block.

According to this solution, coefficient types for which an encoding was performed at the encoder are thus determined according to a process similar to what was done at the encode side.

As noted above, said estimated coefficient encoding merit for a given coefficient type may for instance estimate a ratio between a distortion variation provided by encoding a coefficient having the given type and a rate increase resulting from encoding said coefficient.

According to a first possible embodiment, a quantizer may be selected, for each coefficient for which the coefficient encoding merit prior to encoding is greater than the predetermined block merit, depending on the parameter associated with the concerned coefficient type and on the predetermined block merit, as in the process used at the encoder side; dequantizing symbols may then be performed using the selected quantizer.

According to a second possible embodiment, information designating the quantizer is received with said data and dequantizing symbols may then be performed using the designated quantizer, which avoids implementing again the quantizer selection process just mentioned.

In a corresponding manner to what is mentioned above at the encoder side, the predetermined block merit may be determined in a prior step based on a predetermined frame merit, received this time with said data, and on a number of blocks of a block type of the block per area unit.

According to a third aspect, the invention provides a method for decoding data representing at least one block of pixels, the method comprising:
receiving said data and flags each associated with a coefficient type and indicative of whether coefficients having the concerned coefficient type are encoded;
decoding said data into symbols;
for coefficient types associated with a flag indicating coefficients are encoded, dequantizing symbols into dequantized coefficients; and
transforming dequantized coefficients into pixel values in the spatial domain for said block.

This solution avoids performing, at the decoder side, a process for determining which coefficient types were encoded at the encoder side, as this information is available from the received flags.

It may also be provided in this context that information designating the quantizer is received with said data and that dequantizing symbols is performed using the designated quantizer.

The invention further provides a device for encoding at least one block of pixels, comprising:
a module for transforming pixel values for said block into a set of coefficients each having a coefficient type;
a module for determining an initial coefficient encoding merit for each coefficient type;
a module for quantizing, into quantized symbols, only coefficients for which the initial coefficient encoding merit is greater than a predetermined block merit; and
a module for encoding the quantized symbols into encoded data.

At the decoder side, it is proposed a device for decoding data representing at least one block of pixels comprising:
a module for receiving said data and parameters each representative of a probabilistic distribution of a coefficient type;
a module for decoding said data into symbols;
a module for selecting coefficient types for which a coefficient encoding merit prior to encoding, estimated based on the parameter associated with the concerned coefficient type, is greater than a predetermined block merit;
a module for dequantizing, for selected coefficient types, symbols into dequantized coefficients having a coefficient type among the selected coefficient types; and
a module for transforming dequantized coefficients into pixel values in the spatial domain for said block.

It is also provided a device for decoding data representing at least one block of pixels comprising:
a module for receiving said data and flags each associated with a coefficient type and indicative of whether coefficients having the concerned coefficient type are encoded;
a module for decoding said data into symbols;
a module for dequantizing, for coefficient types associated with a flag indicating coefficients are encoded, symbols into dequantized coefficients; and
a module for transforming dequantized coefficients into pixel values in the spatial domain for said block.

Optional features proposed above in connection with the encoding method may also apply to the decoding method, the encoding device and the decoding device just mentioned.

The invention also provides information storage means, possibly totally or partially removable, able to be read by a computer system, comprising instructions for a computer program adapted to implement an encoding or decoding method as mentioned above, when this program is loaded into and executed by the computer system.

The invention also provides a computer program product able to be read by a microprocessor, comprising portions of software code adapted to implement an encoding or decoding method as mentioned above, when it is loaded into and executed by the microprocessor.

The invention also provides an encoding device for encoding an image substantially as herein described with reference to, and as shown in, FIGS. 1 and 3 of the accompanying drawings.

The invention also provides a decoding device for encoding an image substantially as herein described with reference to, and as shown in, FIGS. 2 and 4 of the accompanying drawings.

According to another aspect of the present invention, there is provided a method of encoding video data comprising:
receiving video data having a first resolution,
downsampling the received first-resolution video data to generate video data having a second resolution lower than said first resolution, and encoding the second resolution video data to obtain video data of a base layer having said second resolution; and
decoding the base layer video data, upsampling the decoded base layer video data to generate decoded video data having said first resolution, forming a difference between the generated decoded video data having said first resolution and said received video data having said first resolution to generate residual data, and compressing the residual data to generate video data of an enhancement layer.

Preferably, the compression of the residual data employs a method embodying the aforesaid first aspect of the present invention.

According to yet another aspect, the invention provides a method of decoding video data comprising:
decoding video data of a base layer to generate decoded base layer video data having a second resolution, lower than a first resolution, and upsampling the decoded base layer video data to generate upsampled video data having the first resolution;
decompressing video data of an enhancement layer to generate residual data having the first resolution; and
forming a sum of the upsampled video data and the residual data to generate enhanced video data.

Preferably, the decompression of the residual data employs a method embodying the aforesaid second or third aspect of the present invention.

In one embodiment the encoding of the second resolution video data to obtain video data of a base layer having said second resolution and the decoding of the base layer video data are in conformity with HEVC.

In one embodiment, the first resolution is UHD and the second resolution is HD. As already noted, it is proposed that the compression of the residual data does not involve temporal prediction and/or that the compression of the residual data also does not involve spatial prediction.

### BRIEF DESCRIPTION OF THE DRAWINGS

Other particularities and advantages of the invention will also emerge from the following description, illustrated by the accompanying drawings, in which:

FIG. 1 schematically shows an encoder for a scalable codec;

FIG. 2 schematically shows the corresponding decoder;

FIG. 3 schematically illustrates the enhancement video encoding module of the encoder of FIG. 1;

FIG. 4 schematically illustrates the enhancement video decoding module of the encoder of FIG. 2;

FIG. 5 illustrates an example of a quantizer based on Voronoi cells;

FIG. 6 shows the correspondence between data in the spatial domain (pixels) and data in the frequency domain;

FIG. 7 illustrates an exemplary distribution over two quanta;

FIG. 8 shows exemplary rate-distortion curves, each curve corresponding to a specific number of quanta;

FIG. 9 shows the rate-distortion curve obtained by taking the upper envelope of the curves of FIG. 8;

FIG. 10 depicts several rate-distortion curves obtained for various possible parameters of the DCT coefficient distribution;

FIG. 11 shows an exemplary embodiment of an encoding process according to the teachings of the invention at the block level;

FIG. 12 shows an exemplary embodiment of an encoding process according to the teachings of the invention at the frame level;

FIG. 13 shows an exemplary embodiment of an encoding process according to the teachings of the invention at the level of a video sequence; and

FIG. 14 shows a particular hardware configuration of a device able to implement methods according to the invention.

### DETAILED DESCRIPTION OF EMBODIMENTS OF THE INVENTION

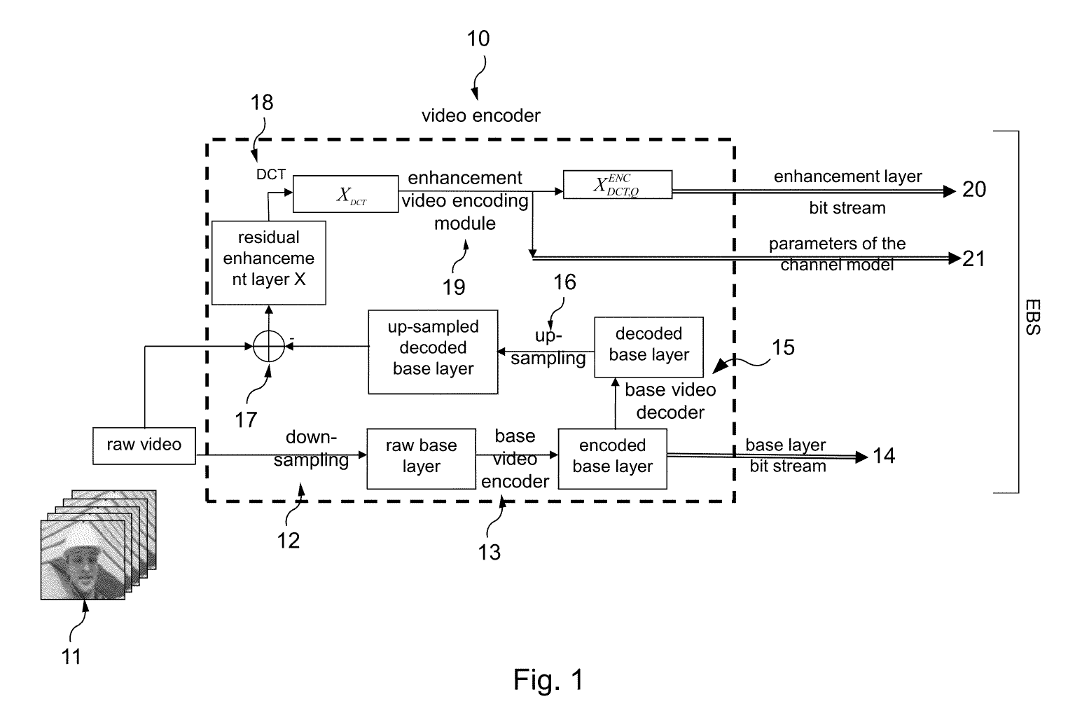

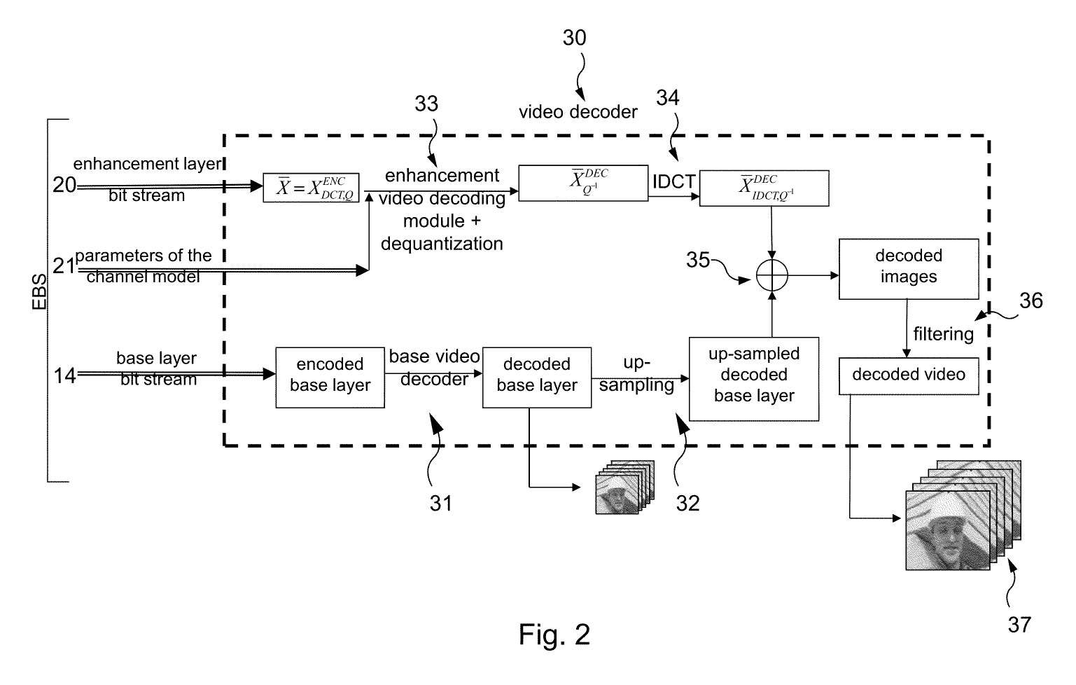

For the detailed description below, focus is made on the encoding of a UHD video as introduced above with reference to FIGS. 1 to 4. It is however to be recalled that the invention applies to the encoding of any image from which a probabilistic distribution of transformed block coefficients can be obtained (e.g. statistically). In particular, it applies to the encoding of an image without temporal prediction and possibly without spatial prediction.

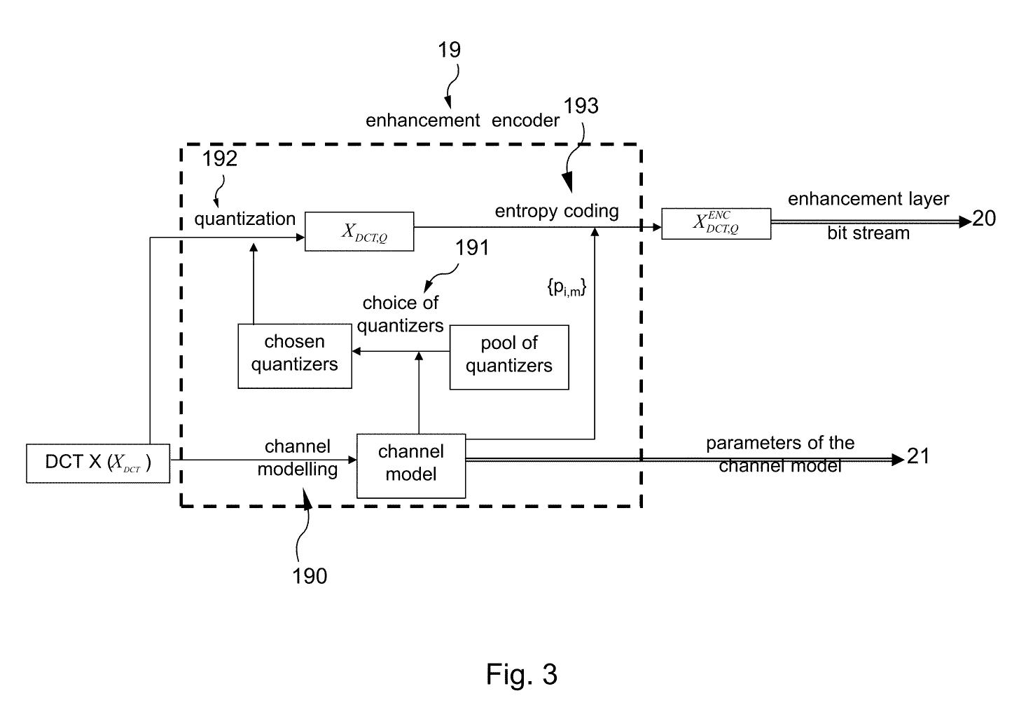

Referring again to FIG. 3, a low resolution version of the initial image has been encoded into an encoded low resolution image, referred above as the base layer; and a residual enhancement image has been obtained by subtracting an interpolated decoded version of the encoded low resolution image from said initial image.

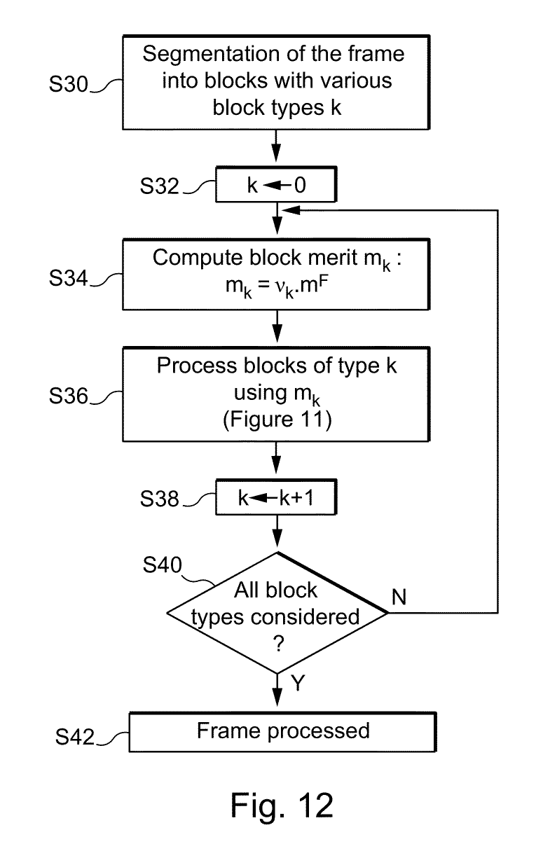

The encoding of the residual enhancement image is now described, first with reference to FIG. 11 focusing on steps performed at the block level.

Conventionally, that residual enhancement image is to be transformed, using for example a DCT transform, to obtain an image of transformed block coefficients. In the Figure, that image is referenced X_{DCT}, which comprises a plurality of DCT blocks, each comprising DCT coefficients.

As an example, the residual enhancement image has been divided into blocks Bₖ, each having a particular block type. Several block types may be considered, owing in particular to various possible sizes for the block. Other parameters than size may be used to distinguish between block types.

It is proposed for instance to use the following block types for luminance residual frames, each block type being defined by a size and an index of energy:
16×16 bottom;
16×16 low;
16×16;
8×8 low;
8×8;
8×8 high.

The choice of the block size is performed here by computing the integral of a morphological gradient (measuring residual activity) on each 16×16 block, before applying the DCT transform. (Such a morphological gradient corresponds to the difference between a dilatation and an erosion of the luminance residual frame, as explained for instance in “Image Analysis and Mathematical Morphology”, Vol. 1, by Jean Serra, Academic Press, Feb. 11, 1984.) If the integral computed for a block is higher than a predetermined threshold, the concerned block is divided into four smaller, here 8×8-, blocks.

Once the block size of a given block is decided, the block type of this block is determined (step S2) based on the morphological integral computed for this block, for instance here by comparing the morphological integral with thresholds defining three bands of residual activity (i.e. three indices of energy) for each possible size (as noted above, bottom, low or normal residual activity for 16×16-blocks and low, normal, high residual activity for 8×8-blocks).

It may be noted that the morphological gradient is used in the present example to measure the residual activity but that other measures of the residual activity may be used, instead or in combination, such as local energy or Laplace's operator.

It is proposed here that chrominance blocks each have a block type inferred from the block type of the corresponding luminance block in the frame. For instance chrominance block types can be inferred by dividing in each direction the size of luminance block types by a factor depending on the resolution ratio between the luminance and the chrominance.

In addition, it is proposed here to define the block type in function of its size and an index of the energy. Other characteristics can also be considered such as for example the encoding mode used for the collocated block of the base layer, referred below as to the “base coding mode”. Typically, Intra blocks of the base layer do not behave the same way as Inter blocks, and blocks with a coded residual in the base layer do not behave the same way as blocks without such a residual (i.e. Skipped blocks).

A DCT transform is then applied to each of the concerned blocks (step S4) in order to obtain a corresponding block of DCT coefficients.

Within a block, the DCT coefficients are associated with an index i (e.g. i=1 to 64), following an ordering used for successive handling when encoding, for example.

Blocks are grouped into macroblocks MBₖ. A very common case for so-called 4:2:0 YUV video streams is a macroblock made of 4 blocks of luminance Y, 1 block of chrominance U and 1 block of chrominance V. Here too, other configurations may be considered.

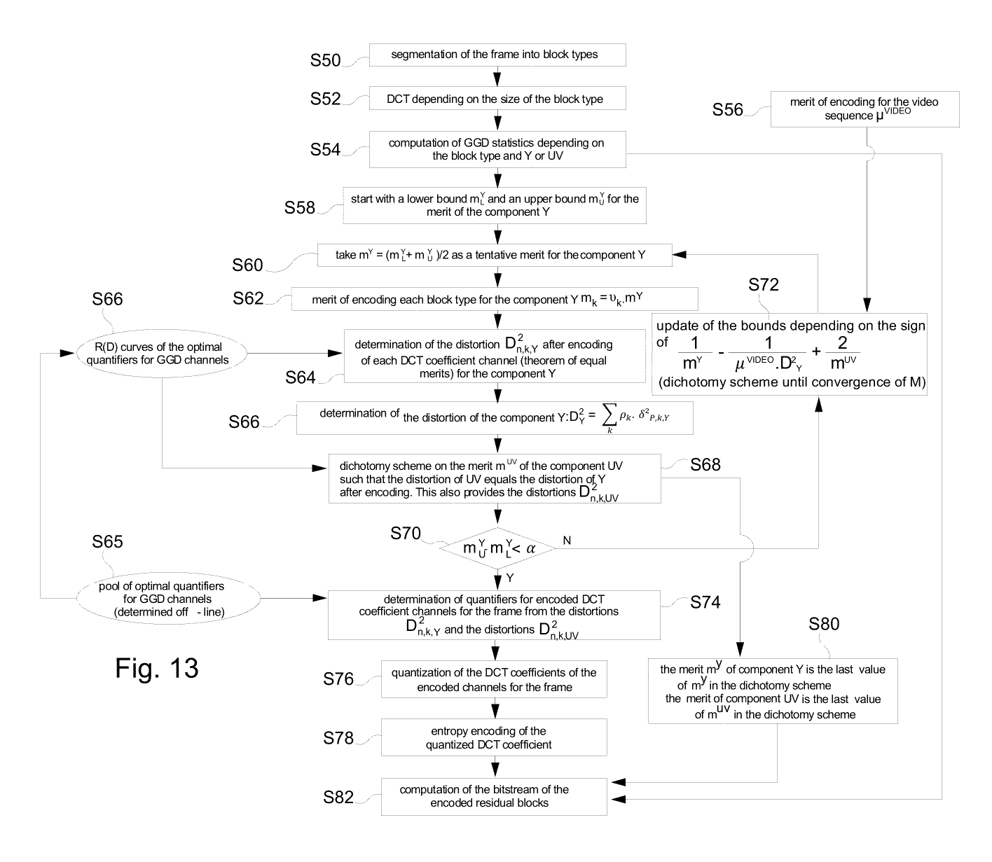

To simplify the explanations, only the coding of the luminance component is described here with reference to FIG. 11. However, the same approach can be used for coding the chrominance components. In addition, it will be further explained with reference to FIG. 13 how to process luminance and chrominance in relation with each other.

Starting from the image X_{DCT}, a probabilistic distribution P of each DCT coefficient is determined using a parametric probabilistic model at step S6. This is referenced 190 in FIG. 3.

Since, in the present example, the image X_{DCT} is a residual image, i.e. information is about a noise residual, it is efficiently modelled by Generalized Gaussian Distributions (GGD) having a zero mean: DCT (X)≈GGD (α,β),

where α,β are two parameters to be determined and the GGD follows the following two-parameter distribution:

$$GGD ( α , β , x ) := \frac{β}{2 αΓ ( 1 / β )} exp ( - {\vert x / α \vert}^{β} ) ,$$

and where Γ is the well-known Gamma function: Γ(z)=∫₀^{∞}t^{z-1}e^{-t}dt.

The DCT coefficients cannot be all modelled by the same parameters and, practically, the two parameters α, β depend on:
the video content. This means that the parameters must be computed for each image or for every group of n images for instance;
the index i of the DCT coefficient within a DCT block Bₖ. Indeed, each DCT coefficient has its own behaviour. A DCT channel is thus defined for the DCT coefficients collocated (i.e. having the same index) within a plurality of DCT blocks (possibly all the blocks of the image). A DCT channel can therefore be identified by the corresponding coefficient index i. For illustrative purposes, if the residual enhancement image X_{DCT} is divided into 8×8 pixel blocks, the modelling 190 has to determine the parameters of 64 DCT channels for each base coding mode; and
the block type defined above. The content of the image, and then the statistics of the DCT coefficients, may be strongly related to the block type because, as explained above, the block type is selected in function of the image content, for instance to use large blocks for parts of the image containing little information.

In addition, since the luminance component Y and the chrominance components U and V have dramatically different source contents, they must be encoded in different DCT channels. For example, if it is decided to encode the luminance component Y on one channel and to encode jointly the chrominance components UV on another channel, 64 channels are needed for the luminance of a block type of size 8×8 and 16 channels are needed for the joint UV chrominance (made of 4×4 blocks) in a case of a 4:2:0 video where the chrominance is down-sampled by a factor two in each direction compared to the luminance. Alternatively, one may choose to encode U and V separately and 64 channels are needed for Y, 16 for U and 16 for V.

At least 64 pairs of parameters for each block type may appear as a substantial amount of data to transmit to the decoder (see parameter bit-stream 21). However, experience proves that this is quite negligible compared to the volume of data needed to encode the residuals of Ultra High Definition (4k2k or more) videos. As a consequence, one may understand that such a technique is preferably implemented on large videos, rather than on very small videos because the parametric data would take too much volume in the encoded bitstream.

For sake of simplicity of explanation, a set of DCT blocks corresponding to the same block type are now considered. The invention may then be applied to each set corresponding to each block type.

To obtain the two parameters αᵢ, βᵢ, defining the probabilistic distribution Pᵢ for a DCT channel i, the Generalized Gaussian Distribution model is fitted onto the DCT block coefficients of the DCT channel, i.e. the DCT coefficients collocated within the DCT blocks of the same block type. Since this fitting is based on the values of the DCT coefficients, the probabilistic distribution is a statistical distribution of the DCT coefficients within a considered channel i.

For example, the fitting may be simply and robustly obtained using the moment of order k of the absolute value of a GGD:

$$\begin{matrix}{M}_{k}^{{α}_{i} , {β}_{i}} := {E ( {\vert GGD ( {α}_{i} , {β}_{i} ) \vert}^{k} )}_{( k ∈ {R}_{+} )} \\ = {\int }_{- ∞}^{∞} {\vert x \vert}^{k} GGD ( {α}_{i} , {β}_{i} , x ) d x \\ = \frac{{α}_{i}^{k} Γ ( ( 1 + k ) / {β}_{i} )}{Γ ( 1 / {β}_{i} )} .\end{matrix}$$

Determining the moments of order 1 and of order 2 from the DCT coefficients of channel i makes it possible to directly obtain the value of parameter βᵢ:

$$\frac{{M}_{2}}{{( {M}_{1} )}^{2}} = \frac{Γ ( 1 / {β}_{i} ) Γ ( 3 / {β}_{i} )}{{Γ ( 2 / {β}_{i} )}^{2}}$$

The value of the parameter βᵢ can thus be estimated by computing the above ratio of the two first and second moments, and then the inverse of the above function of βᵢ.

Practically, this inverse function may be tabulated in memory of the encoder instead of computing Gamma functions in real time, which is costly.

The second parameter αᵢ may then be determined from the first parameter βᵢ and the second moment, using the equation: M₂=σ²=αᵢ²Γ(3/βᵢ)/Γ(1/βᵢ).

The two parameters αᵢ, βᵢ being determined for the DCT coefficients i, the probabilistic distribution Pᵢ of each DCT coefficient i is defined by

$${P}_{i} ( x ) = GGD ( {α}_{i} , {β}_{i} , x ) = \frac{{β}_{i}}{2 {α}_{i} Γ ( 1 / {β}_{i} )} exp ( - {\vert x / {α}_{i} \vert}^{{β}_{i}} ) .$$

Referring to FIG. 3, a quantization 193 of the DCT coefficients is to be performed in order to obtain quantized symbols or values. As explained below, it is proposed here to first determine a quantizer per DCT channel so as to optimize a rate-distortion criterion.

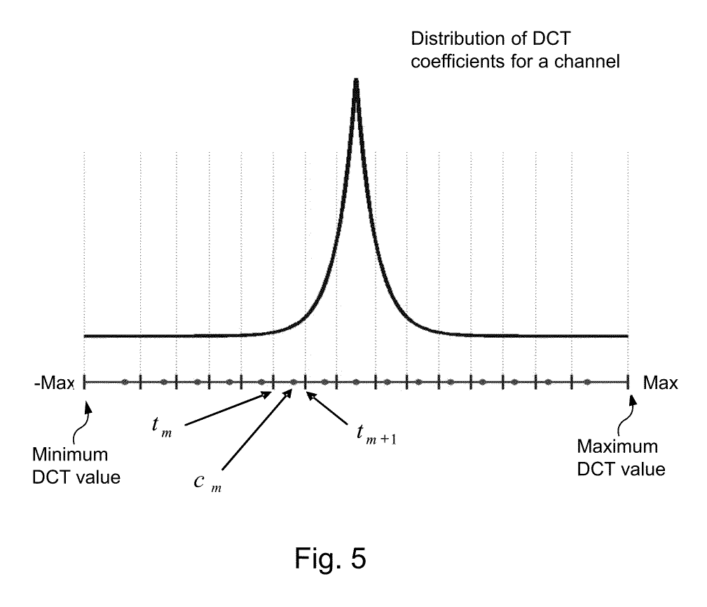

FIG. 5 illustrates an exemplary Voronoi cell based quantizer.

A quantizer is made of M Voronoi cells distributed along the values of the DCT coefficients. Each cell corresponds to an interval [tₘ,tₘ₊₁], called quantum Qₘ.

Each cell has a centroid cₘ, as shown in the Figure.

The intervals are used for quantization: a DCT coefficient comprised in the interval [tₘ,tₘ₊₁] is quantized to a symbol aₘ associated with that interval.

For their part, the centroids are used for de-quantization: a symbol aₘ associated with an interval is de-quantized into the centroid value cₘ of that interval.

The quality of a video or still image may be measured by the so-called Peak-Signal-to-Noise-Ratio or PSNR, which is dependent upon a measure of the L2-norm of the error of encoding in the pixel domain, i.e. the sum over the pixels of the squared difference between the original pixel value and the decoded pixel value. It may be recalled in this respect that the PSNR may be expressed in dB as:

$$10 \cdot {log}_{10} ( \frac{MA {X}^{2}}{MSE} ) ,$$

where MAX is the maximal pixel value (in the spatial domain) and MSE is the mean squared error (i.e. the above sum divided by the number of pixels concerned).

However, as noted above, most of video codecs compress the data in the DCT-transformed domain in which the energy of the signal is much better compacted.

The direct link between the PSNR and the error on DCT coefficients is now explained.

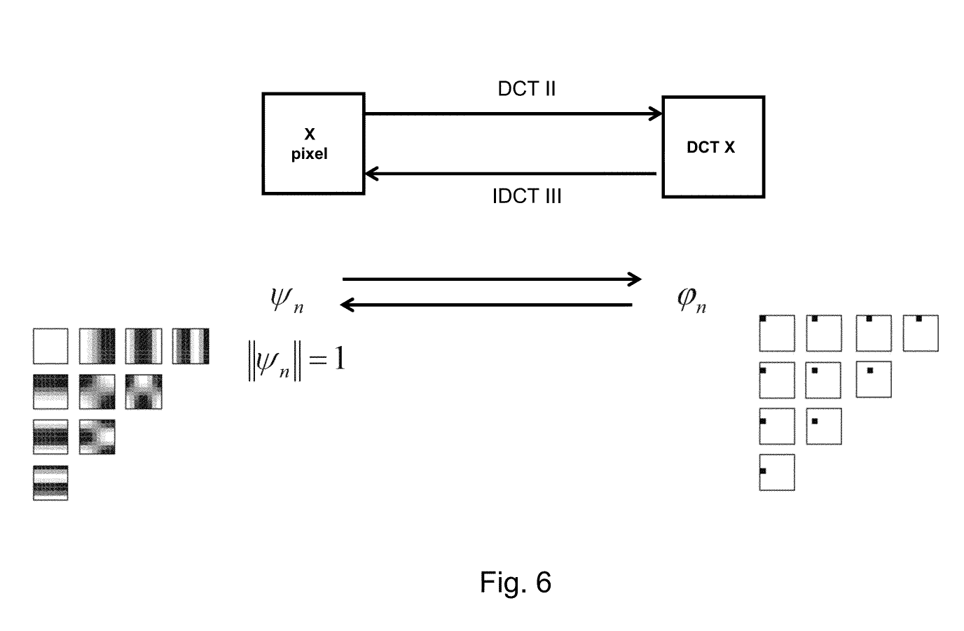

For a residual block, we note ψₙ its inverse DCT (or IDCT) pixel base in the pixel domain as shown on FIG. 6. If one uses the so-called IDCT III for the inverse transform, this base is orthonormal: ∥ψₙ∥=1.

On the other hand, in the DCT domain, the unity coefficient values form a base φₙ which is orthogonal. One writes the DCT transform of the pixel block X as follows:

$${X}_{DCT} = {\sum }_{n} {d}^{n} {ϕ}_{n} ,$$

where dⁿ is the value of the n-th DCT coefficient. A simple base change leads to the expression of the pixel block as a function of the DCT coefficient values:

$$X = IDCT ( {X}_{DCT} ) = IDCT {\sum }_{n} {d}^{n} {ϕ}_{n} = {\sum }_{n} {d}^{n} IDCT ( {ϕ}_{n} ) = {\sum }_{n} {d}^{n} {ψ}_{n} .$$

If the value of the de-quantized coefficient dⁿ after decoding is denoted d_{Q}ⁿ, one sees that (by linearity) the pixel error block is given by:

$${ɛ}_{X} = {\sum }_{n} ( {d}^{n} - {d}_{Q}^{n} ) {ψ}_{n}$$

The mean L₂-norm error on all blocks, is thus:

$$E ( {‖ {ɛ}_{X} ‖}_{2}^{2} ) = E ( {\sum }_{n} {\vert {d}^{n} - {d}_{Q}^{n} \vert}^{2} ) = {\sum }_{n} E ( {\vert {d}^{n} - {d}_{Q}^{n} \vert}^{2} ) = {\sum }_{n} {D}_{n}^{2}$$

where Dₙ² is the mean quadratic error of quantization on the n-th DCT coefficient, or squared distortion for this type of coefficient. The distortion is thus a measure of the distance between the original coefficient (here the coefficient before quantization) and the decoded coefficient (here the dequantized coefficient).

It is thus proposed below to control the video quality by controlling the sum of the quadratic errors on the DCT coefficients. In particular, this control is preferable compared to the individual control of each of the DCT coefficient, which is a priori a sub-optimal control.

In the embodiment described here, it is proposed to determine (i.e. to select in step 191 of FIG. 3) a set of quantizers (to be used each for a corresponding DCT channel), the use of which results in a mean quadratic error having a target value Dₜ² while minimizing the rate obtained. This corresponds to step S16 in FIG. 11.

In view of the above correspondence between PSNR and the mean quadratic error Dₙ² on DCT coefficients, these constraints can be written as follows:

$$minimize R = {\sum }_{n} {R}_{n} ( {D}_{n} ) s . t . {\sum }_{n} {D}_{n}^{2} = {D}_{t}^{2} \qquad ( A )$$

where R is the total rate made of the sum of individual rates Rₙ for each DCT coefficient. In case the quantization is made independently for each DCT coefficient, the rate Rₙ depends only on the distortion Dₙ of the associated n-th DCT coefficient.

It may be noted that the above minimization problem (A) may only be fulfilled by optimal quantizers which are solution of the problem

minimize Rₙ(Dₙ)s.t. E(|dⁿ−d_{Q}ⁿ|²)=Dₙ² (B).

This statement is simply proven by the fact that, assuming a first quantizer would not be optimal following (B) but would fulfil (A), then a second quantizer with less rate but the same distortion can be constructed (or obtained). So, if one uses this second quantizer, the total rate R has been diminished without changing the total distortion ΣₙDₙ²; this is in contradiction with the first quantifier being a minimal solution of the problem (A).

As a consequence, the rate-distortion minimization problem (A) can be split into two consecutive sub-problems without losing the optimality of the solution:
first, determining optimal quantizers and their associated rate-distortion curves Rₙ(Dₙ) following the problem (B), which will be done in the present case for GGD channels as explained below; and
second, by using optimal quantizers, the problem (A) is changed into the problem (A_opt):

$$minimize R = {\sum }_{n} {R}_{n} ( {D}_{n} ) s . t . {\sum }_{n} {D}_{n}^{2} = {D}_{t}^{2} and \\ {R}_{n} ( {D}_{n} ) is optimal . \qquad ( A\_opt )$$

Based on this analysis, it is proposed as further explained below:
to compute off-line (step S8 in FIG. 11) optimal quantizers adapted to possible probabilistic distributions of each DCT channel (thus resulting in the pool of quantizers of FIG. 3); and
to select (step S16) one of these pre-computed optimal quantizers for each DCT channel (i.e. each type of DCT coefficient) such that using the set of selected quantizers results in a global distortion corresponding to the target distortion Dₜ² with a minimal rate (i.e. a set of quantizers which solves the problem A_opt).

It is now described a possible embodiment for the first step S8 of computing optimal quantizers for possible probabilistic distributions, here Generalised Gaussian Distributions.

It is proposed to change the previous complex formulation of problem (B) into the so-called Lagrange formulation of the problem: for a given parameter λ>0, we determine the quantization in order to minimize a cost function such as D²+λR. We thus get an optimal rate-distortion couple (D_{λ},R_{λ}). In case of a rate control (i.e. rate minimization) for a given target distortion Δₜ, the optimal parameter λ>0 is determined by

$${λ}_{{Δ}_{t}} = {arg min}_{λ , {D}_{λ} \leq {Δ}_{t}} {R}_{λ}$$

(i.e. the value of λ for which the rate is minimum while fulfiling the constraint on distortion) and the associated minimum rate is

$${λ}_{{Δ}_{t}} = {arg min}_{λ , {D}_{λ} \leq {Δ}_{t}} {R}_{λ}$$

As a consequence, by solving the problem in its Lagrange formulation, for instance following the method proposed below, it is possible to plot a rate distortion curve associating a resulting minimum rate to each distortion value (Δₜ [symbol] R_{Δ}_{ₜ}) which may be computed off-line as well as the associated quantization, i.e. quantizer, making it possible to obtain this rate-distortion pair.

It is precisely proposed here to formulate problem (B) into a continuum of problems (B_lambda) having the following Lagrange formulation

minimize Dₙ²+λRₙ(Dₙ)s.t. E(|x−dₘ|²)=Dₙ² (B_lambda).

The well-known Chou-Lookabaugh-Gray algorithm is a good practical way to perform the required minimization. It may be used with any distortion distance d; we describe here a simplified version of the algorithm for the L²-distance. This is an iterative process from any given starting guessed quantization.

As noted above, this algorithm is performed here for each of a plurality of possible probabilistic distributions (in order to obtain the pre-computed optimal quantizers for the possible distributions to be encountered in practice), and for a plurality of possible numbers M of quanta. It is described below when applied for a given probabistic distribution P and a given number M of quanta.

In this respect, as the parameter alpha α (or equivalently the standard deviation σ of the Generalized Gaussian Definition) can be moved out of the distortion parameter Dₙ² because it is a homothetic parameter, only optimal quantizers with unity standard deviation σ=1 need to be determined in the pool of quantizers.

Taking advantage of this remark, in the proposed embodiment, the GGD representing a given DCT channel will be normalized before quantization (i.e. homothetically transformed into a unity standard deviation GGD), and will be de-normalized after de-quantization. Of course, this is possible because the parameters (in particular here the parameter α or equivalently the standard deviation σ) of the concerned GGD model are sent to the decoder in the video bit-stream.

Before describing the algorithm itself, the following should be noted.

The position of the centroids cₘ is such that they minimize the distortion δₘ² inside a quantum, in particular one must verify that ∂_{c}_{ₘ}δₘ²=0 (as the derivative is zero at a minimum).

As the distortion δₘ of the quantization, on the quantum Qₘ, is the mean error E(d(x; cₘ)) for a given distortion function or distance d, the distortion on one quantum when using the L²-distance is given by δₘ²=∫_{Q}_{ₘ}|x−cₘ|²P(x)dx and the nullification of the derivative thus gives: cₘ=∫_{Q}_{ₘ}xP(x)dx/Pₘ, where Pₘ is the probability of x to be in the quantum Qₘ and is simply the following integral Pₘ=∫_{Q}_{ₘ}P(x)dx.

Turning now to minimization of the cost function C=D²+λR, and considering that the rate reaches the entropy of the quantized data:

$$R = - {\sum }_{m = 1}^{M} {P}_{m} {log}_{2} {P}_{m} ,$$

the nullification of the derivatives of the cost function for an optimal solution can be written as:

0=∂ₜ_{ₘ₊₁}C=∂ₜ_{ₘ₊₁}[Δₘ²−λPₘ ln Pₘ+Δₘ₊₁²−λPₘ₊₁ ln Pₘ₊₁]

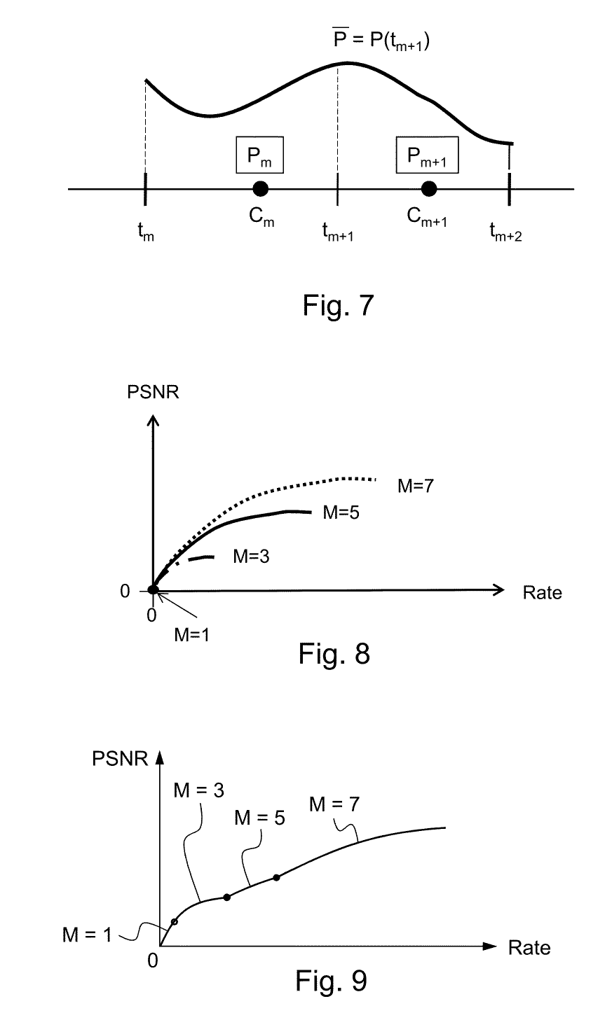

Let us set P̅=P(tₘ₊₁) the value of the probability distribution at the point tₘ₊₁. From simple variational considerations, see FIG. 7, we get

∂ₜ_{ₘ₊₁}Pₘ= P̅ and ∂ₜ_{ₘ₊₁}Pₘ₊₁= P̅.

Then, a bit of calculation leads to

$$\begin{matrix}{\partial }_{{t}_{m + 1}} {Δ}_{m}^{2} = {\partial }_{{t}_{m + 1}} {\int }_{{t}_{m}}^{{t}_{m + 1}} {\vert x - {c}_{m} \vert}^{2} P ( x ) d x \\ = \overline{P} {\vert {t}_{m + 1} - {c}_{m} \vert}^{2} + {\int }_{{t}_{m}}^{{t}_{m + 1}} {\partial }_{{t}_{m + 1}} {\vert x - {c}_{m} \vert}^{2} P ( x ) d x \\ = \overline{P} {\vert {t}_{m + 1} - {c}_{m} \vert}^{2} - 2 {\partial }_{{t}_{m + 1}} {c}_{m} {\int }_{{t}_{m}}^{{t}_{m + 1}} ( x - {c}_{m} ) P ( x ) d x \\ = \overline{P} {\vert {t}_{m + 1} - {c}_{m} \vert}^{2}\end{matrix}$$

as well as

∂ₜ_{ₘ₊₁}Δₘ₊₁²=− P̅|tₘ₊₁−cₘ₊₁|².

As the derivative of the cost is now explicitly calculated, its cancellation gives:

$$0 = \overline{P} {\vert {t}_{m + 1} - {d}_{m} \vert}^{2} - λ \overline{P} ln {P}_{m} - λ {P}_{m} \frac{\overline{P}}{{P}_{m}} - \overline{P} {\vert {t}_{m + 1} - {d}_{m + 1} \vert}^{2} + λ \overline{P} ln {P}_{m + 1} + λ {P}_{m} \frac{\overline{P}}{{P}_{m}} ,$$

which leads to a useful relation between the quantum boundaries tₘ,tₘ₊₁ and the centroids cₘ:

$${t}_{m + 1} = \frac{{c}_{m} + {c}_{m + 1}}{2} - λ \frac{ln {P}_{m + 1} - ln {P}_{m}}{2 ( {c}_{m + 1} - {c}_{m} )} .$$

Thanks to these formulae, the Chou-Lookabaugh-Gray algorithm can be implemented by the following iterative process:

1. Start with arbitrary quanta Qₘ defined by a plurality of limits tₘ

2. Compute the probabilities Pₘ by the formula Pₘ=∫_{Q}_{ₘ}P(x)dx

3. Compute the centroids cₘ by the formula cₘ=∫_{Q}_{ₘ}xP(x)dx/Pₘ

4. Compute the limits tₘ of new quanta by the formula

$${t}_{m + 1} = \frac{{c}_{m} + {c}_{m + 1}}{2} - λ \frac{ln {P}_{m + 1} - ln {P}_{m}}{2 ( {c}_{m + 1} - {c}_{m} )}$$

5. Compute the cost C=D²+λR by the formula

$$C = {\sum }_{m = 1}^{M} {Δ}_{m}^{2} - λ {P}_{m} ln {P}_{m}$$

6. Loop to 2. until convergence of the cost C

When the cost C has converged, the current values of limits tₘ and centroids cₘ define a quantization, i.e. a quantizer, with M quanta, which solves the problem (B_lambda), i.e. minimizes the cost function for a given value λ, and has an associated rate value R_{λ} and an distortion value D_{λ}.

Such a process is implemented for many values of the Lagrange parameter λ (for instance 100 values comprised between 0 and 50). It may be noted that for λ equal to 0, there is no rate constraint, which corresponds to the so-called Lloyd quantizer.

In order to obtain optimal quantizers for a given parameter β of the corresponding GGD, the problems (B_lambda) are to be solved for various odd (by symmetry) values of the number M of quanta and for the many values of the parameter λ. A rate-distortion diagram for the optimal quantizers with varying M is thus obtained, as shown on FIG. 8.

It turns out that, for a given distortion, there is an optimal number M of needed quanta for the quantization associated to an optimal parameter λ. In brief, one may say that optimal quantizers of the general problem (B) are those associated to a point of the upper envelope of the rate-distortion curves making this diagram, each point being associated with a number of quanta (i.e. the number of quanta of the quantizer leading to this point of the rate-distortion curve). This upper envelope is illustrated on FIG. 9. At this stage, we have now lost the dependency on λ of the optimal quantizers: for a given rate (or a given distortion) corresponds only one optimal quantizer whose number of quanta M is fixed.

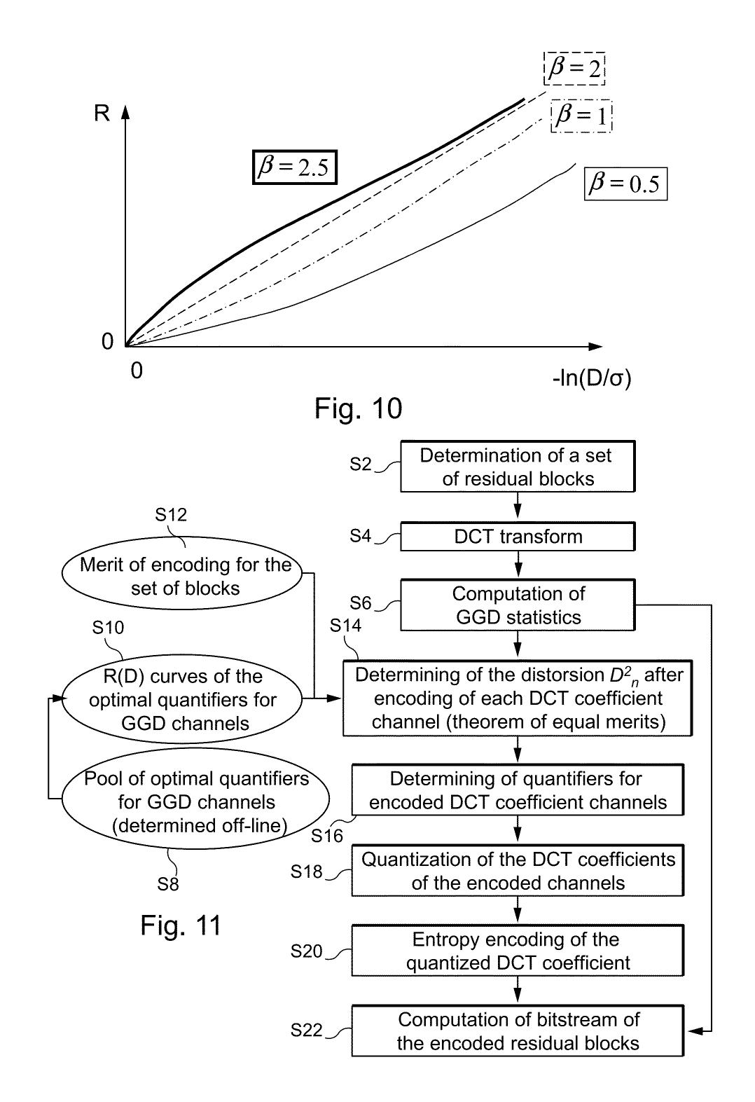

Based on observations that the GGD modelling provides a value of β almost always between 0.5 and 2 in practice, and that only a few discrete values are enough for the precision of encoding, it is proposed here to tabulate β every 0.1 in the interval between 0.2 and 2.5. Considering these values of β (i.e. here for each of the 24 values of β taken in consideration between 0.2 and 2.5), rate-distortion curves, depending on β, are obtained (step S10) as shown on FIG. 10. It is of course possible to obtain according to the same process rate-distortion curves for a larger number of possible values of β.

Each curve may in practice be stored in the encoder in a table containing, for a plurality of points on the curve, the rate and distortion (coordinates) of the point concerned, as well as features defining the associated quantizer (here the number of quanta and the values of limits tₘ and centroids cₘ for the various quanta). For instance, a few hundreds of quantizers may be stored for each β up to a maximum rate, e.g. of 5 bits per DCT coefficient, thus forming the pool of quantizers mentioned in FIG. 3. It may be noted that a maximum rate of 5 bits per coefficient in the enhancement layer makes it possible to obtain good quality in the decoded image. Generally speaking, it is proposed to use a maximum rate per DCT coefficient equal or less than 10 bits, for which value near lossless coding is provided.

Before turning to the selection of quantizers (step S16), for the various DCT channels and among these optimal quantizers stored in association with their corresponding rate and distortion when applied to the concerned distribution (GGD with a specific parameter β), it is proposed here to select which part of the DCT channels are to be encoded.

Based on the observation that the rate decreases monotonously as a function of the distortion induced by the quantizer, precisely in each case in the manner shown by the curves just mentioned, it is possible to write the relationship between rate and distortion as follows: Rₙ=ƒₙ(−ln(Dₙ/σₙ)),

where σₙ is the normalization factor of the DCT coefficient, i.e. the GGD model associated to the DCT coefficient has σₙ for standard deviation, and where ƒₙ′≧0 in view of the monotonicity just mentioned.

In particular, without encoding (equivalently zero rate) leads to a quadratic distortion of value σₙ² and we deduce that 0=ƒₙ(0).

Finally, one observes that the curves are convex for parameters β lower than two: β≦2 [symbol] ƒₙ″≧0.

It is proposed here to consider the merit of encoding a DCT coefficient. More encoding basically results in more rate Rₙ (in other words, the corresponding cost) and less distortion Dₙ² (in other words the resulting gain or advantage).

Thus, when dedicating a further bit to the encoding of the video (rate increase), it should be determined on which DCT coefficient this extra rate is the most efficient. In view of the analysis above, an estimation of the merit M of encoding may be obtained by computing the ratio of the benefit on distortion to the cost of encoding:

$${M}_{n} := \vert \frac{Δ {D}_{n}^{2}}{Δ {R}_{n}} \vert .$$

Considering the distortion decreases by an amount ε, then a first order development of distortion and rates gives

$${( D - ɛ )}^{2} = {D}^{2} - 2 ɛ D + o ( ɛ )$$

$$and$$

$$\begin{matrix}R ( D - ɛ ) = {f}_{n} ( - ln ( ( D - ɛ ) / σ ) ) \\ = {f}_{n} ( - ln ( D / σ ) - ln ( 1 - ɛ / D ) ) \\ = {f}_{n} ( - ln ( D / σ ) + ɛ / D + o ( ɛ ) ) \\ = {f}_{n} ( - ln ( D / σ ) ) + ɛ {f}^{′} ( - ln ( D / σ ) ) / D .\end{matrix}$$

As a consequence, the ratio of the first order variations provides an explicit formula for the merit of encoding:

$${M}_{n} ( {D}_{n} ) = \frac{2 {D}_{n}^{2}}{{f}_{n}^{′} ( - ln ( {D}_{n} / {σ}_{n} ) )} .$$

If the initial merit Mₙ⁰ is defined as the merit of encoding at zero rate, i.e. before any encoding, this initial merit Mₙ⁰ can thus be expressed as follows using the preceding formula:

$${M}_{n}^{0} := {M}_{n} ( {σ}_{n} ) = \frac{2 {σ}_{n}^{2}}{{f}_{n}^{′} ( 0 )}$$

(because as noted above no encoding leads to a quadratic distortion of value σₙ²).

It is thus possible, starting from the pre-computed and stored rate-distortion curves, to determine the function ƒₙ associated with a given DCT channel and to compute the initial merit Mₙ⁰ of encoding the corresponding DCT coefficient (the value ƒₙ′(0) being determined by approximation thanks to the stored coordinates of rate-distortion curves).

It may further be noted that, for β lower than two (which is in practice almost always true), the convexity of the rate distortion curves teaches us that the merit is an increasing function of the distortion.

In particular, the initial merit is thus an upper bound of the merit: Mₙ(Dₙ)≦Mₙ⁰.

It will now be shown that, when satisfying the optimisation criteria defined above, all encoded DCT coefficients in the block have the same merit after encoding. Furthermore, this does not only apply to one block only, but as long as the various functions ƒₙ used in each DCT channel are the unchanged, i.e. in particular for all blocks in a given block type. Hence the common merit value for encoded DCT coefficients will now be referred to as the merit of the block type.

The above property of equal merit after encoding may be shown for instance using the Karush-Kuhn-Tucker (KKT) necessary conditions of optimality. In this goal, the quality constraint

$${\sum }_{n} {D}_{n}^{2} = {D}_{t}^{2}$$

can De rewritten as h=0 with

$$h ( {D}_{1} , {D}_{2} , … ) := {\sum }_{n} {D}_{n}^{2} - {D}_{t}^{2} .$$

The distortion of each DCT coefficient is upper bounded by the distortion without coding: Dₙ≦σₙ, and the domain of definition of the problem is thus a multi-dimensional box Ω={(D₁, D₂, . . . ); Dₙ≦σₙ}={(D₁, D₂, . . . ); gₙ≦0}, defined by the functions gₙ(Dₙ):=Dₙ−σₙ.

Thus, the problem can be restated as follows:

minimize R(D₁,D₂, . . . )s.t. h=0, gₙ≦0 (A_opt′).

Such an optimization problem under inequality constrains can effectively be solved using so-called Karush-Kuhn-Tucker (KKT) necessary conditions of optimality.

In this goal, the relevant KKT function Λ is defined as follows:

$$Λ ( {D}_{1} , {D}_{2} , … , λ , {μ}_{1} , {μ}_{2} , … ) := R - λ h - {\sum }_{n} {μ}_{n} {g}_{n} .$$

The KKT necessary conditions of minimization are
stationarity: dΛ=0,
equality: h=0,
inequality: gₙ≦0,
dual feasibility: μₙ≧0,
saturation: μₙgₙ=0.

It may be noted that the parameter λ in the KKT function above is unrelated to the parameter λ used above in the Lagrange formulation of the optimisation problem meant to determine optimal quantizers.

If gₙ=0, the n-th condition is said to be saturated. In the present case, it indicates that the n-th DCT coefficient is not encoded.

By using the specific formulation Rₙ=ƒₙ(−ln(Dₙ/σₙ)) of the rate depending on the distortion discussed above, the stationarity condition gives:

0=∂_{D}_{ₙ}Λ=∂_{D}_{ₙ}Rₙ−λ∂_{D}_{ₙ}h−μₙ∂_{D}_{ₙ}gₙ=−ƒₙ′/Dₙ−2λDₙ−μₙ,

i.e. 2λDₙ²=−μₙDₙ−ƒₙ′.

By summing on n and taking benefit of the equality condition, this leads to

$$2 λ {D}_{t}^{2} = - {\sum }_{n} {μ}_{n} {D}_{n} - {\sum }_{n} {f}_{n}^{′} \cdot {(}^{*} )$$

In order to take into account the possible encoding of part of the coefficients only as proposed above, the various possible indices n are distributed into two subsets:
the set I⁰={n; μₙ=0} of non-saturated DCT coefficients (i.e. of encoded DCT coefficients) for which we have μₙDₙ=0 and Dₙ²=−ƒₙ′/2λ, and
the set I⁺={n; μₙ>0} of saturated DCT coefficients (i.e. of DCT coefficients not encoded) for which we have μₙDₙ=ƒₙ′−2λσₙ².

From (*), we deduce

$$2 λ {D}_{t}^{2} = - {\sum }_{{I}^{+}} {μ}_{n} {D}_{n} - {\sum }_{n} {f}_{n}^{′} = {\sum }_{{I}^{+}} {f}_{n}^{′} + 2 λ {\sum }_{{I}^{+}} {σ}_{n}^{2} - {\sum }_{n} {f}_{n}^{′}$$

and by gathering the λ's

$$2 λ ( {D}_{t}^{2} - {\sum }_{{I}^{+}} {σ}_{n}^{2} ) = {\sum }_{{I}^{0}} {f}_{n}^{′} .$$

As a consequence, for a non-saturated coefficient (nεI⁰), i.e. a coefficient to be encoded, we obtain:

$${D}_{n}^{2} = ( {D}_{t}^{2} - {\sum }_{{I}^{+}} {σ}_{n}^{2} ) {f}_{n}^{′} ( - ln ( {D}_{n} / {σ}_{n} ) ) / {\sum }_{m ∈ {I}^{0}} {f}_{m}^{′} ( - ln ( {D}_{m} / {σ}_{m} ) ) .$$

This formula for the distortion makes it possible to rewrite the above formula giving the merit Mₙ (Dₙ) as follows for non-saturated coefficients:

$${M}_{n} ( {D}_{n} ) = 2. ( {D}_{t}^{2} - {\sum }_{{I}^{+}} {σ}_{n}^{2} ) / {\sum }_{m ∈ {I}^{0}} {f}_{m}^{′} ( - ln ( {D}_{m} / {σ}_{m} ) ) .$$

Clearly, the right side of the equality does not depend on the DCT channel n concerned. Thus, for a block type k, for any DCT channel n for which coefficients are encoded, the merit associated with said channel after encoding is the same: Mₙ=mₖ.

Another proof of the property of common merit after encoding is the following: supposing that there are two encoded DCT coefficients with two different merits M1<M2, if an infinitesimal amount of rate from coefficient 1 is put on coefficient 2 (which is possible because coefficient 1 is one of the encoded coefficients and this does not change the total rate), the distortion gain on coefficient 2 would then be strictly bigger than the distortion loss on coefficient 1 (because M1<M2). This would thus provide a better distortion with the same rate, which is in contradiction with the optimality of the initial condition with two different merits.

As a conclusion, if the two coefficients 1 and 2 are encoded and if their respective merits M1 and M2 are such that M1<M2, then the solution is not optimal.

Furthermore, all non-coded coefficients have a merit smaller than the merit of the block type (i.e. the merit of coded coefficients after encoding).

In view of the property of equal merits of encoded coefficients when optimisation is satisfied, it is proposed here to encode only coefficients for which the initial encoding merit

$${M}_{n}^{0} = \frac{2 {σ}_{n}^{2}}{{f}_{n}^{′} ( 0 )}$$

is greater than a predetermined target block merit mₖ.

For each coefficient to be encoded, the quantization to be performed is selected to obtain the target block merit as the merit of the coefficient after encoding: first, the corresponding distortion, which is thus such that

$${M}_{n} ( {D}_{n} ) = \frac{2 {D}_{n}^{2}}{{f}_{n}^{′} ( - ln ( {D}_{n} / {σ}_{n} ) )} = {m}_{k} ,$$

can be found by dichotomy using stored rate-distortion curves (step S14); the quantizer associated (see steps S8 and S10 above) with the distortion found is then selected (step S16).

Then, quantization is performed at step S18 by the chosen (or selected) quantizers to obtain the quantized data X_{DCT,Q} representing the DCT image. Practically, these data are symbols corresponding to the index of the quantum (or interval or Voronoi cell in 1D) in which the value of the concerned coefficient of X_{DCT} falls in.

The entropy coding of step S20 may be performed by any known coding technique like VLC coding or arithmetic coding. Context adaptive coding (CAVLC or CABAC) may also be used.

The encoded data can then be transmitted together with parameters allowing in particular the decoder to use the same quantizers as those selected and used for encoding as described above.

According to a first possible embodiment, the transmitted parameters may include the parameters defining the distribution for each DCT channel, i.e. the parameter α (or equivalently the standard deviation σ) and the parameter β computed at the encoder side for each DCT channel, as shown in step S22.

Based on these parameters received in the data stream, the decoder may deduce the quantizers to be used (a quantizer for each DCT channel) thanks to the selection process explained above at the encoder side (the only difference being that the parameters β for instance are computed from the original data at the encoder side whereas they are received at the decoder side).

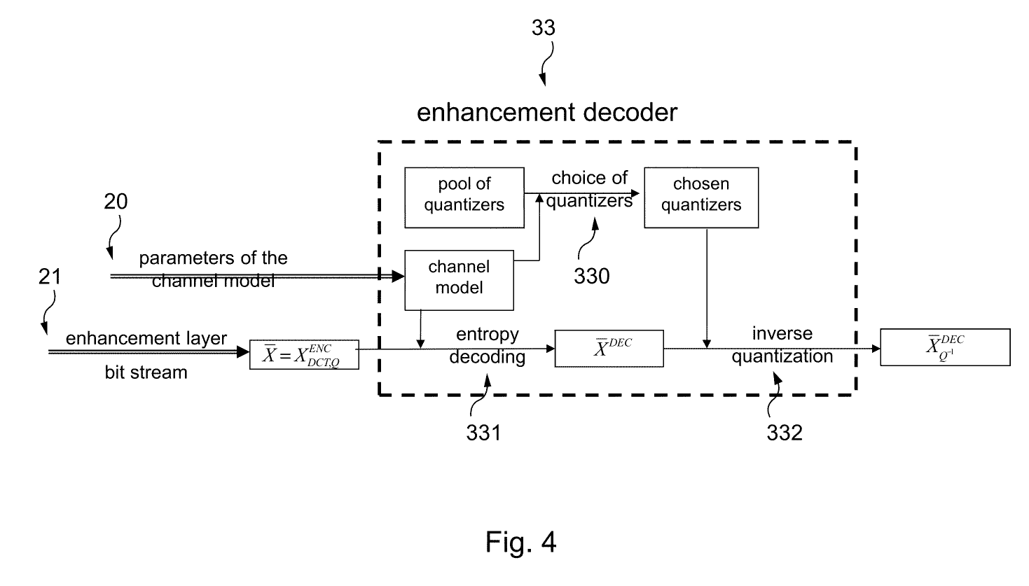

Dequantization (step 332 of FIG. 4) can thus be performed with the selected quantizers (which are the same as those used at encoding because they are selected the same way).

According to a second possible embodiment, the transmitted parameters may include a flag per DCT channel indicating whether the coefficients of the concerned DCT channel are encoded or not, and, for encoded channels, the parameters β and the standard deviation σ(or equivalently the parameter σ). This helps minimizing the amount of information to be sent because channel parameters are sent only for encoded channels. According to a possible variation, in addition to flags indicating whether the coefficients of a given DCT channel are encoded or not, information can be transmitted that designates, for each encoded DCT channel, the quantizer used at encoding. In this case, there is thus no need to perform a quantizer selection process at the decoder side.

Dequantization (step 332 of FIG. 4) can thus be performed at the decoder by use of the identified quantizers for DCT channels having a received flag indicating the DCT channel was encoded.

FIG. 12 shows the encoding process implemented in the present example at the level of the frame, which includes in particular determining the target block merit for the various block types.

First, the frame is segmented at step S30 into a plurality of blocks each having a given block type k, for instance in accordance with the process described above based on residual activity.

A parameter k designating the block type currently considered is then initialised at step S32.

The target block merit mₖ for the block type k currently considered is the computed at step S34 based on a predetermined frame merit m^{F} and on a number of blocks vₖ of the given block type per area unit, here according to the formula:

mₖ=vₖ·m^{F}.

For instance, one may choose the area unit as being the area of a 16×16 block, i.e. 256 pixels. In this case, vₖ=1 for block types of size 16×16, vₖ=4 for block types of size 8×8 etc. One also understands that the method is not limited to square blocks; for instance vₖ=2 for block types of size 16×8.

This type of computation makes it possible to obtain a balanced encoding between block types, i.e. here a common merit of encoding per pixel (equal to the frame merit m^{F}) for all block types.

This is because the variation of the pixel distortion Δδ_{P,k}² for the block type k is the sum

$${\sum }_{codedn} Δ {D}_{n , k}^{2}$$

of the distortion variations provided by the various encoded DCT coefficients, and can thus be rewritten as follows thanks to the (common) block merit:

$${Δδ}_{P , k}^{2} = {m}_{k} . {\sum }_{codedn} Δ {R}_{n , k} = {m}_{k} . Δ {R}_{k}$$

(where ΔRₖ is the rate variation for a block of type k). Thus, the merit of encoding per pixel is:

$$\frac{{Δδ}_{P , k}^{2}}{Δ {U}_{k}} = \frac{{m}_{k} . Δ {R}_{k}}{{v}_{k} . Δ {R}_{k}} = {m}^{F}$$

(where Uₖ is the rate per area unit for the block type concerned) and has a common value over the various block types.

Blocks having the block type k currently considered are then each encoded by the process described above with reference to FIG. 11 using the block merit mₖ just determined as the target block merit in step S14 of FIG. 11.

The next block type is then considered by incrementing k (step S38), checking whether all block types have been considered (step S40) and looping to step S34 if all block types have not been considered.

If all block types have been considered, the whole frame has been processed (step S42), which ends the encoding process at the frame level presented here.

FIG. 13 shows the encoding process implemented in the present example at the level of the video sequence, which includes in particular determining the frame merit for luminance frames Y as well as for chrominance frames U,V of the video sequence.

The process shown in FIG. 13 applies to a specific frame and is to be applied to each frame of the video sequence concerned.

The frame is first segmented into blocks each having a block type at step S50, in a similar manner as was explained above for step S30. As mentioned above, the segmentation is determined based on the residual activity of the luminance frame Y and is also applied to the chrominance frames U,V.

A DCT transform is then applied (step S52) to each block thus defined. The DCT transform is adapted to the type of the block concerned, in particular to its size.

Parameters representative of the statistical distribution of coefficients (here αᵢ, βᵢ as explained above) are then computed (step S54) both for luminance frames and for chrominance frames, in each case for each block type, each time for the various coefficient types.

A loop is then entered (at step S58 described below) to determine by dichotomy a luminance frame merit m^{Y} and a chrominance frame merit m^{UV} linked by the following relationship:

$$\frac{1}{{μ}^{VIDEO} . {D}_{Y}^{2}} - \frac{2}{{m}^{UV}} = \frac{1}{{m}^{Y}} ,$$

where μ^{VIDEO} is a selectable video merit obtained for instance based on user selection of a quality level at step S56 and D_{Y}² is the frame distortion for the luminance frame after encoding and decoding.

Each of the determined luminance frame merit m^{Y} and chrominance frame merit m^{UV} may then be used as the frame merit m^{F} in a process similar to the process described above with reference to FIG. 12, as further explained below.

The relationship given above makes it possible to adjust (to the value) μ^{VIDEO}) the local video merit defined as the ratio between the variation of the PSNR (already defined above) of the luminance ΔPSNR_{Y} and the corresponding variation of the total rate ΔR_{YUV} (including not only luminance but also chrominance frames). This ratio is generally considered when measuring the efficiency of a coding method.

This relationship is also based on the following choices:
the quality of luminance frames is the same as the quality of chrominance frames: D_{Y}²=D_{UV}²=(D_{U}²+D_{V}²)/2;
the merit of U chrominance frames is the same as the merit of V chrominance frames: m^{U}=m^{V}=m^{UV}.

As explained above, the merit m^{F} of encoding per pixel is the same whatever the block in a frame and the relationship between distortion and rate thus remains valid at the frame level (by summing over the frame the distortions of the one hand and the rates on the other hand, each corresponding distortion and rate defining) a constant ratio m^{F}): ΔD_{Y}²=m^{Y}·ΔR_{Y}, ΔD_{U}²=m^{UV}·ΔR_{U} and ΔD_{V}²=m^{UV}·ΔR_{V}, where ΔR_{Y}, ΔR_{U} and ΔR_{V} are the rate variations respectively for the luminance frame, the U chrominance frame and the V chrominance frame.

Thus,

$$Δ {R}_{YUV} = \frac{Δ {D}_{Y}^{2}}{{m}^{Y}} + \frac{Δ {D}_{U}^{2}}{{m}^{UV}} + \frac{Δ {D}_{V}^{2}}{{m}^{UV}} = Δ {D}_{Y}^{2} . ( \frac{1}{{m}^{Y}} + \frac{2}{{m}^{UV}} ) .$$

As the PSNR is the logarithm of the distortion D_{Y}², its variation ΔPSNR_{Y} can be written as follows at the first order:

$$Δ {PSNR}_{Y} = \frac{Δ {D}_{Y}^{2}}{{D}_{Y}^{2}} ,$$

and the video merit can thus be restated as follows based on the above assumptions and remarks:

$$\frac{Δ {PSNR}_{Y}}{Δ {R}_{YUV}} = \frac{Δ {PSNR}_{Y}}{Δ {R}_{Y}} \frac{Δ {R}_{Y}}{Δ {R}_{YUV}} = \frac{Δ {D}_{Y}^{2} . {m}^{Y}}{{D}_{Y}^{2} . Δ {D}_{Y}^{2}} \frac{Δ {D}_{Y}^{2}}{{m}^{Y} . Δ {D}_{Y}^{2} ( \frac{1}{{m}^{Y}} + \frac{2}{{m}^{UV }} )} = \frac{1}{{D}_{Y}^{2} . ( \frac{1}{{m}^{Y}} + \frac{2}{{m}^{UV}} )} .$$

This ratio is equal to the chosen value μ^{VIDEO} when the above relationship

$$( \frac{1}{{μ}^{VIDEO} . {D}_{Y}^{2}} - \frac{2}{{m}^{UV}} = \frac{1}{{m}^{Y}} )$$

is satisfied.

Going back to the loop process implemented to determine the luminance frame merit m^{Y} and the chrominance frame merit m^{UV} as mentioned above, a lower bound m_{L}^{Y} and an upper bound m_{U}^{Y} for the luminance frame merit are initialized at step S58 at predetermined values. The lower bound m_{L}^{Y} and the upper bound m_{U}^{Y} define an interval, which includes the luminance frame merit and which will be reduced in size (divided by two) at each step of the dichotomy process. At initialization step S58, the lower bound m_{L}^{Y} may be chosen as strictly positive but small, corresponding to a nearly lossless encoding, while the upper bound m_{U}^{Y} is chosen for instance greater than all initial encoding merits (over all DCT channels and all block types).

A temporary luminance frame merit m^{Y} is computed (step S60) as equal to

$$\frac{{m}_{L}^{Y} + {m}_{U}^{Y}}{2}$$

(i.e. in the middle of the interval).

A block merit is then computed at step S62 for each of the various block types, as explained above with reference to FIG. 12 (see in particular step S34) according to the formula: mₖ=vₖ·m^{Y}. Block merits are computed based on the temporary luminance frame merit defined above. The next steps are thus based on this temporary value which is thus a tentative value for the luminance frame merit.

For each block type k in the luminance frame, the distortions D_{n,k,Y}² after encoding of the various DCT channels n are then determined at step S64 in accordance with what was described with reference to FIG. 11, in particular step S14, based on the block merit mₖ just computed and on optimal rate-distortion curves determined beforehand at step S66, in the same manner as in step S10 of FIG. 11.

The frame distortion for the luminance frame D_{Y}² can then be determined at step S66 by summing over the block types thanks to the formula:

$${D}_{Y}^{2} = {\sum }_{k} {ρ}_{k} . {δ}_{P , k , Y}^{2} = {\sum }_{k} {ρ}_{k} . ( {\sum }_{n} {D}_{n , k , Y}^{2} ) ,$$

where ρₖ is the density of a block type in the frame, i.e. the ratio between the total area for blocks having the concerned block type k and the total area of the frame.

It is then sought, for instance by dichotomy at step S68 and also based on optimal rate-distortion curves predetermined at step S66, a temporary chrominance frame merit m^{UV} such that the distortions after encoding D_{n,k,U}², D_{n,k,V}², obtained by implementing a process according to FIG. 12 using m^{UV} as the frame merit, result in chrominance frame distortions D_{U}², D_{V}² satisfying D_{Y}²=(D_{U}²+D_{V}²)/2.

It may be noted in this respect that the relationship between distortions of the DCT channels and the frame distortion, given above for the luminance frame, is also valid for each of the chrominance frames U,V.

It is then checked at step S70 whether the interval defined by the lower bound m_{L}^{Y} and the upper bound m_{U}^{Y} have reached a predetermined required accuracy α, i.e. whether m_{U}^{Y}−m_{L}^{Y}<α.

If this is not the case, the dichotomy process will be continued by selecting of the first half of the interval and the second half of the interval as the new interval to be considered, depending on the sign of

$$\frac{1}{{m}^{Y}} - \frac{1}{{μ}^{VIDEO} . {D}_{Y}^{2}} + \frac{2}{{m}^{UV}} ,$$

which will thus converge towards zero such that the relationship defined above is satisfied. The lower bound m_{L}^{Y} and the upper bound m_{U}^{Y} are adapted consistently with the selected interval (step S72) and the process loops at step S60.

If the required accuracy is reached, the process continues at step S74 where quantizers are selected in a pool of quantizers predetermined at step S65 and associated with points of the optimal rate-distortion curves already used (see explanations relating to step S8 in FIG. 11), based on the distortions values D_{n,k,Y}², D_{n,k,U}², D_{n,k,V}² obtained during the last iteration of the dichotomy process (steps S64 and S68 described above).

The coefficients of the blocks of the frames (which coefficients where computed at step S52) are then quantized at step S76 using the selected quantizers.

The quantized coefficients are then entropy encoded at step S78.

A bit stream to be transmitted is then computed based on encoded coefficients (step S82). The bit stream also includes parameters αᵢ, βᵢ, representative of the statistical distribution of coefficients computed at step S54, as well as frame merits m^{Y}, m^{UV} determined at step S60 and S68 during the last iteration of the dichotomy process.

Transmitting the frame merits makes it possible to select the quantizers for dequantization at the decoder according to a process similar to FIG. 12 (with respect to the selection of quantizers), without the need to perform the dichotomy process.

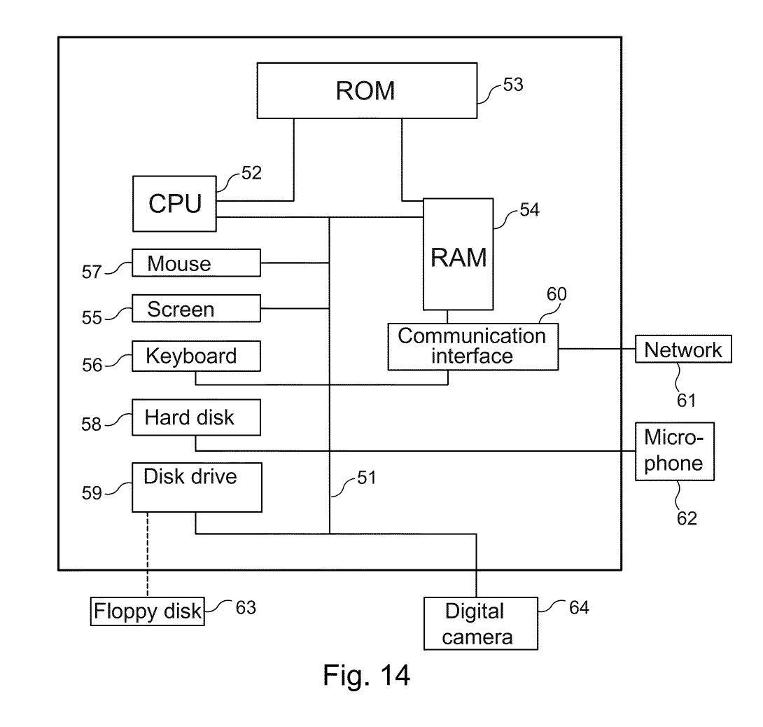

With reference now to FIG. 14, a particular hardware configuration of a device for encoding or decoding images able to implement methods according to the invention is now described by way of example.

A device implementing the invention is for example a microcomputer 50, a workstation, a personal digital assistant, or a mobile telephone connected to various peripherals. According to yet another embodiment of the invention, the device is in the form of a photographic apparatus provided with a communication interface for allowing connection to a network.

The peripherals connected to the device comprise for example a digital camera 64, or a scanner or any other image acquisition or storage means, connected to an input/output card (not shown) and supplying image data to the device.

The device 50 comprises a communication bus 51 to which there are connected:
a central processing unit CPU 52 taking for example the form of a microprocessor;
a read only memory 53 in which may be contained the programs whose execution enables the methods according to the invention. It may be a flash memory or EEPROM;
a random access memory 54, which, after powering up of the device 50, contains the executable code of the programs of the invention necessary for the implementation of the invention. As this memory 54 is of random access type (RAM), it provides fast access compared to the read only memory 53. This RAM memory 54 stores in particular the various images and the various blocks of pixels as the processing is carried out (transform, quantization, storage of the reference images) on the video sequences;
a screen 55 for displaying data, in particular video and/or serving as a graphical interface with the user, who may thus interact with the programs according to the invention, using a keyboard 56 or any other means such as a pointing device, for example a mouse 57 or an optical stylus;
a hard disk 58 or a storage memory, such as a memory of compact flash type, able to contain the programs of the invention as well as data used or produced on implementation of the invention;
an optional diskette drive 59, or another reader for a removable data carrier, adapted to receive a diskette 63 and to read/write thereon data processed or to process in accordance with the invention; and
a communication interface 60 connected to the telecommunications network 61, the interface 60 being adapted to transmit and receive data.

In the case of audio data, the device 50 is preferably equipped with an input/output card (not shown) which is connected to a microphone 62.

The communication bus 51 permits communication and interoperability between the different elements included in the device 50 or connected to it. The representation of the bus 51 is non-limiting and, in particular, the central processing unit 52 unit may communicate instructions to any element of the device 50 directly or by means of another element of the device 50.

The diskettes 63 can be replaced by any information carrier such as a compact disc (CD-ROM) rewritable or not, a ZIP disk or a memory card. Generally, an information storage means, which can be read by a micro-computer or microprocessor, integrated or not into the device for processing a video sequence, and which may possibly be removable, is adapted to store one or more programs whose execution permits the implementation of the method according to the invention.

The executable code enabling the coding device to implement the invention may equally well be stored in read only memory 53, on the hard disk 58 or on a removable digital medium such as a diskette 63 as described earlier. According to a variant, the executable code of the programs is received by the intermediary of the telecommunications network 61, via the interface 60, to be stored in one of the storage means of the device 50 (such as the hard disk 58) before being executed.

The central processing unit 52 controls and directs the execution of the instructions or portions of software code of the program or programs of the invention, the instructions or portions of software code being stored in one of the aforementioned storage means. On powering up of the device 50, the program or programs which are stored in a non-volatile memory, for example the hard disk 58 or the read only memory 53, are transferred into the random-access memory 54, which then contains the executable code of the program or programs of the invention, as well as registers for storing the variables and parameters necessary for implementation of the invention.

It will also be noted that the device implementing the invention or incorporating it may be implemented in the form of a programmed apparatus. For example, such a device may then contain the code of the computer program(s) in a fixed form in an application specific integrated circuit (ASIC).

The device described here and, particularly, the central processing unit 52, may implement all or part of the processing operations described in relation with FIGS. 1 to 13, to implement methods according to the present invention and constitute devices according to the present invention.

The above examples are merely embodiments of the invention, which is not limited thereby.

1. A method for encoding at least one block of pixels, comprising the steps of:
transforming pixel values for said block into a set of coefficients each having a coefficient type;
determining an initial coefficient encoding merit for each coefficient type;
quantizing, into quantized symbols, only coefficients for which the initial coefficient encoding merit is greater than a predetermined block merit; and
encoding the quantized symbols into encoded data.

2. An encoding method according to claim 1, wherein determining an initial coefficient encoding merit for a given coefficient type includes estimating a ratio between a distortion variation provided by encoding a coefficient having the given type and a rate increase resulting from encoding said coefficient.

3. An encoding method according claim 1, comprising the following steps:
determining, for each coefficient type, at least one parameter representative of a probabilistic distribution of coefficients having the concerned coefficient type; and
determining the initial coefficient encoding merit for a given coefficient type based on the parameter for the given coefficient type.

4. An encoding method according to claim 3, comprising, for each coefficient for which the initial coefficient encoding merit is greater than the predetermined block merit, selecting a quantizer depending on the parameter for the concerned coefficient type and on the predetermined block merit.

5. An encoding method according to claim 4, wherein said quantizer is selected such that a merit of encoding the concerned coefficient beyond encoding using said quantizer equals the predetermined block merit.

6. An encoding method according to claim 3, including a step of sending encoded data and parameters determined for each coefficient type.

7. An encoding method according to claim 1, including a step of sending encoded data and flags each associated with a coefficient type and indicative of whether the coefficient having the concerned coefficient type is encoded.

8. An encoding method according to claim 1, comprising a prior step of determining the predetermined block merit based on a predetermined frame merit and on a number of blocks of a block type of the block per area unit.

9. A method for decoding data representing at least one block of pixels, the method comprising:
receiving said data and parameters each representative of a probabilistic distribution of a coefficient type;
decoding said data into symbols;
selecting coefficient types for which a coefficient encoding merit prior to encoding, estimated based on the parameter associated with the concerned coefficient type, is greater than a predetermined block merit;
for selected coefficient types, dequantizing symbols into dequantized coefficients having a coefficient type among the selected coefficient types; and
transforming dequantized coefficients into pixel values in the spatial domain for said block.

10. A decoding method according to claim 9, wherein said estimated coefficient encoding merit for a given coefficient type estimates a ratio between a distortion variation provided by encoding a coefficient having the given type and a rate increase resulting from encoding said coefficient.

11. A decoding method according to claim 9, comprising, for each coefficient for which the coefficient encoding merit prior to encoding is greater than the predetermined block merit, selecting a quantizer depending on the parameter associated with the concerned coefficient type and on the predetermined block merit, wherein symbols dequantizing is performed using the selected quantizer.

12. A decoding method according to claim 11, wherein said quantizer is selected such that a merit of encoding the concerned coefficient beyond encoding using said quantizer equals the predetermined block merit.

13. A decoding method according to claim 9, wherein information designating the quantizer is received with said data and wherein symbols dequantizing is performed using the designated quantizer.

14. A decoding method according to claim 9, comprising a prior step of determining the predetermined block merit based on a predetermined frame merit, received with said data, and on a number of blocks of a block type of the block per area unit.

15. A method for decoding data representing at least one block of pixels, the method comprising:
receiving said data and flags each associated with a coefficient type and indicative of whether coefficients having the concerned coefficient type are encoded;
decoding said data into symbols;
for coefficient types associated with a flag indicating coefficients are encoded, dequantizing symbols into dequantized coefficients; and
transforming dequantized coefficients into pixel values in the spatial domain for said block.

16. A decoding method according to claim 15, wherein information designating the quantizer is received with said data and wherein dequantizing symbols is performed using the designated quantizer.

17. A device for encoding at least one block of pixels, comprising:
a module for transforming pixel values for said block into a set of coefficients each having a coefficient type;
a module for determining an initial coefficient encoding merit for each coefficient type;
a module for quantizing, into quantized symbols, only coefficients for which the initial coefficient encoding merit is greater than a predetermined block merit; and
a module for encoding the quantized symbols into encoded data.

18. An encoding device according to claim 17, wherein the module for determining an initial coefficient encoding merit for a given coefficient type is adapted to estimate a ratio between a distortion variation provided by encoding a coefficient having the given type and a rate increase resulting from encoding said coefficient.

19. An encoding device according claim 17, comprising a module for determining, for each coefficient type, at least one parameter representative of a probabilistic distribution of coefficients having the concerned coefficient type, wherein the module for determining the initial coefficient encoding merit is adapted to determine the initial coefficient encoding merit for a given coefficient type based on the parameter for the given coefficient type.

20. An encoding device according to claim 19, comprising a module for selecting, for each coefficient for which the initial coefficient encoding merit is greater than the predetermined block merit, a quantizer depending on the parameter for the concerned coefficient type and on the predetermined block merit.

21. An encoding device according to claim 20, wherein the module for selecting said quantizer is adapted to select the quantizer such that a merit of encoding the concerned coefficient beyond encoding using said quantizer equals the predetermined block merit.

22. An encoding device according to claim 19, comprising a module for sending encoded data and parameters determined for each coefficient type.

23. An encoding device according to claim 17, including a module for sending encoded data and flags each associated with a coefficient type and indicative of whether the coefficient having the concerned coefficient type is encoded.

24. An encoding device according to claim 17, comprising a module for determining the predetermined block merit based on a predetermined frame merit and on a number of blocks of a block type of the block per area unit.

25. A device for decoding data representing at least one block of pixels comprising:
a module for receiving said data and parameters each representative of a probabilistic distribution of a coefficient type;
a module for decoding said data into symbols;
a module for selecting coefficient types for which a coefficient encoding merit prior to encoding, estimated based on the parameter associated with the concerned coefficient type, is greater than a predetermined block merit;
a module for dequantizing, for selected coefficient types, symbols into dequantized coefficients having a coefficient type among the selected coefficient types; and
a module for transforming dequantized coefficients into pixel values in the spatial domain for said block.

26. A decoding device according to claim 25, wherein said estimated coefficient encoding merit for a given coefficient type corresponds to a ratio between a distortion variation provided by encoding a coefficient having the given type and a rate increase resulting from encoding said coefficient.

27. A decoding device according to claim 25, comprising a module for selecting, for each coefficient for which the coefficient encoding merit prior to encoding is greater than the predetermined block merit, a quantizer depending on the parameter associated with the concerned coefficient type and on the predetermined block merit, wherein the module for dequantizing symbols is adapted to perform dequantizing using the selected quantizer.

28. A decoding device according to claim 27, wherein the module for selecting said quantizer is adapted to select said quantizer such that a merit of encoding the concerned coefficient beyond encoding using said quantizer equals the predetermined block merit.

29. A decoding device according to claim 25, wherein the module for receiving data is adapted to receive information designating the quantizer and wherein the module for dequantizing symbols is adapted to perform dequantizing using the designated quantizer.

30. A decoding device according to claim 25, comprising a module for determining the predetermined block merit based on a predetermined frame merit, received with said data, and on a number of blocks of a block type of the block per area unit.

31. A device for decoding data representing at least one block of pixels comprising:
a module for receiving said data and flags each associated with a coefficient type and indicative of whether coefficients having the concerned coefficient type are encoded;
a module for decoding said data into symbols;
a module for dequantizing, for coefficient types associated with a flag indicating coefficients are encoded, symbols into dequantized coefficients; and
a module for transforming dequantized coefficients into pixel values in the spatial domain for said block.

32. A decoding device according to claim 31, wherein the module for receiving is adapted to receive information designating the quantizer and wherein the module for dequantizing symbols is adapted to perform dequantizing using the designated quantizer.

33. Information storage means, possibly totally or partially removable, able to be read by a computer system, comprising instructions for a computer program adapted to implement a method according to claim 1, when this program is loaded into and executed by the computer system.

34. Computer program product able to be read by a microprocessor, comprising portions of software code adapted to implement a method according to claim 1, when it is loaded into and executed by the microprocessor.

35. A method of encoding video data comprising:
receiving video data having a first resolution,
downsampling the received first resolution video data to generate video data having a second resolution lower than said first resolution, and encoding the second resolution video data to obtain video data of a base layer having said second resolution; and
decoding the base layer video data, upsampling the decoded base layer video data to generate decoded video data having said first resolution, forming a difference between the generated decoded video data having said first resolution and said received video data having said first resolution to generate residual data, and compressing, by a method according to claim 1, the residual data to generate video data of an enhancement layer.

36. A method of decoding video data comprising:
decoding video data of a base layer to generate decoded base layer video data having a second resolution, lower than a first resolution, and upsampling the decoded base layer video data to generate upsampled video data having the first resolution;
decompressing, by a method according to claim 9, video data of an enhancement layer to generate residual data having the first resolution; and
forming a sum of the upsampled video data and the residual data to generate enhanced video data.
